(19) United States
(12) Patent Application Publication
(10) Pub. No.: US 2018/0354176 A1
(43) Pub. Date: Dec. 13, 2018

(54) HUB EXTRUSION CASTING MOLD

(71) Applicant: CITIC Dicastal CO.,LTD., Qinhuangdao (CN)

(72) Inventors: Jinling Yang, Qinhuangdao (CN); Li Yang, Qinhuangdao (CN); Zhen Wang, Qinhuangdao (CN); Zhichong Liu, Qinhuangdao (CN)

(21) Appl. No.: 15/688,902

(22) Filed: Aug. 29, 2017

(30) Foreign Application Priority Data
Jun. 13, 2017 (CN) 201710443132.5

(51) Int. Cl. B29C 45/40

(52) U.S. Cl. CPC B29C 45/4005; B29C 47/003

(57) ABSTRACT

Disclosed is an improved hub extrusion casting mold. Springs (1) are arranged in guide posts (5), a large ejector rod (9) and a small ejector rod (21) are fixed onto a discharge plate (23) by an ejector rod fixing plate (4), an upper mold core (10) is fixed into an upper mold fixing plate (7-1) via connecting screws (8), locking modules are fixed onto the upper mold fixing plate, slanting guide posts (7) are fixed in the cavity formed by an upper connecting plate (6) and the upper mold fixing plate, hydraulic cylinder assemblies (14) are fixed by fixing plates (13) to assist in combination and separation of side molds (12), a side mold guide rail (15) is connected with a pressure plate (16), the pressure plate is connected with a lower mold (20) and a bottom plate (17), and a stamping guide sleeve is connected with the bottom plate.

### CROSS-REFERENCE TO RELATED APPLICATIONS

This application is filed based upon and claims priority to Chinese Patent Application No. 201710443132.5, filed on Jun. 13, 2017, the entire contents of which are incorporated herein by reference.

### TECHNICAL FIELD

The present disclosure relates to a mold, specifically to a lower pressing method hub extrusion casting mold.

### BACKGROUND

Extrusion casting is also referred to as liquid forging, is a light alloy hub molding process between a low pressure casting process and a forging process, and is a metal molding method in which molten liquid metal is extruded into a hot mold and the liquid metal is rheologically punched, crystallized and solidified into a solid blank under the action of external pressure for the mold. It has the advantages of good product performance and high tissue density of the forging process, and also has the characteristics of simplicity and easy molding of the forging process. The requirement of the extrusion casting process for molds is relatively high, and there are no molds available for industrial production at present.

### SUMMARY

An improved hub extrusion casting mold includes springs, bolts, an upper large plate, an ejector rod fixing plate, guide posts, an upper connecting plate, slanting guide posts, an upper mold fixing plate, connecting screws, a large ejector rod, an upper mold core, side molds, fixing plates, hydraulic cylinder assemblies, a side mold guide rail, a pressure plate, a bottom plate, a sprue bush, a lower liquid pressure head, a stamping guide sleeve, a lower mold, locking modules, a small ejector rod, a small guide post, guide sleeves and a discharge plate.

The springs are arranged in the guide posts, the large ejector rod and the small ejector rod are fixed onto the discharge plate by the ejector rod fixing plate, the upper mold core is fixed into the upper mold fixing plate via the connecting screws, the locking modules are fixed onto the upper mold fixing plate, the slanting guide posts are fixed in the cavity formed by the upper connecting plate and the upper mold fixing plate, the side molds are combined and separated via the slanting guide posts and the hydraulic cylinder assemblies, the hydraulic cylinder assemblies are fixed by the fixing plates to assist in combination and separation of the side molds, the side mold guide rail is connected with the pressure plate, the pressure plate is connected with the lower mold and the bottom plate, and the stamping guide sleeve is connected with the bottom plate and achieves the effect of guiding the liquid pressure head.

The side molds are combined and locked under the action of resultant force of the slanting guide posts, the locking modules and the hydraulic cylinder systems, and the problem that a blank cannot be separated from the mold is solved by a discharge ejector mechanism composed of the springs, the discharge plate, the large ejector rod and the small ejector rod.

### BRIEF DESCRIPTION OF THE DRAWINGS

FIG. 1 is a schematic diagram of an improved hub extrusion casting mold of the present disclosure.

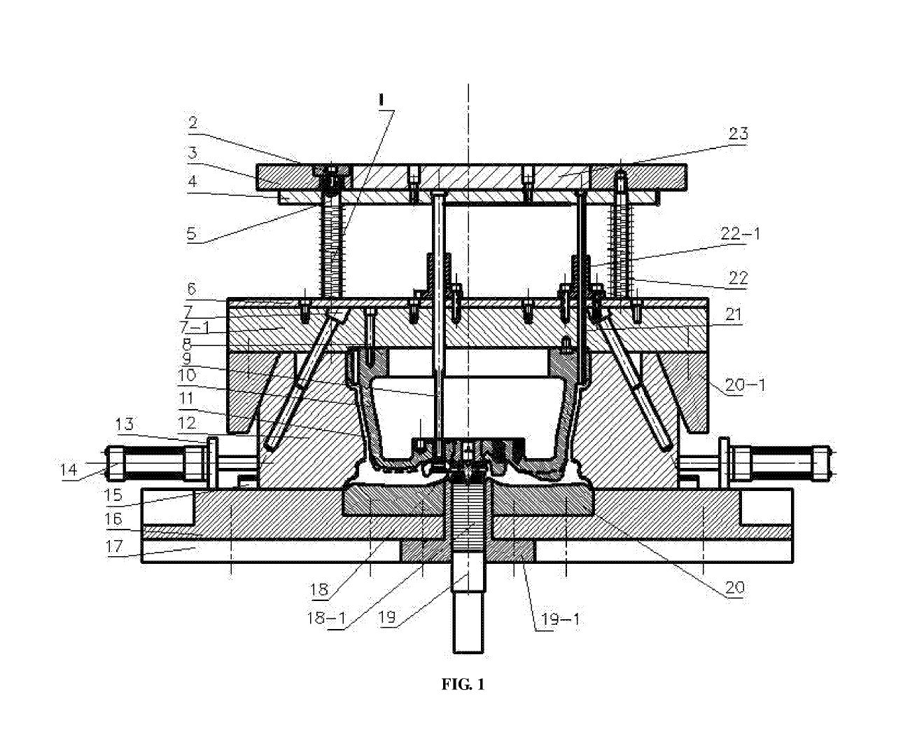

### LIST OF REFERENCE NUMERALS

1 spring

2 bolt

3 upper large plate

4 ejector rod fixing plate

5 guide post

6 upper connecting plate

7 slanting guide post

7-1 upper mold fixing plate

8 connecting screw

9 large ejector rod

10 upper mold core

11 blank

12 side mold

13 fixing plate

14 hydraulic cylinder assembly

15 side mold guide rail

16 pressure plate

17 bottom plate

18 sprue bush

18-1 liquid magnesium alloy

19 lower liquid pressure head

19-1 stamping guide sleeve

20 lower mold

20-1 locking module

21 small ejector rod

22 small guide post

22-1 guide sleeve

23 discharge plate

24 blank tray

### DETAILED DESCRIPTION

An improved hub extrusion casting mold includes springs 1, bolts 2, an upper large plate 3, an ejector rod fixing plate 4, guide posts 5, an upper connecting plate 6, slanting guide posts 7, an upper mold fixing plate 7-1, connecting screws 8, a large ejector rod 9, an upper mold core 10, a blank 11, side molds 12, fixing plates 13, hydraulic cylinder assemblies 14, a side mold guide rail 15, a pressure plate 16, a bottom plate 17, a sprue bush 18, a lower liquid pressure head 19, a stamping guide sleeve 19-1, a lower mold 20, locking modules 20-1, a small ejector rod 21, a small guide post 22, guide sleeves 22-1 and a discharge plate 23.

The springs 1 are arranged in the guide posts 5, the large ejector rod 9 and the small ejector rod 21 are fixed onto the discharge plate 23 by the ejector rod fixing plate 4, the upper mold core 10 is fixed into the upper mold fixing plate 7-1 via the connecting screws 8, the locking modules 20-1 are fixed onto the upper mold fixing plate 7-1, the slanting guide posts 7 are fixed in the cavity formed by the upper connecting plate 6 and the upper mold fixing plate 7-1, the side molds 12 are combined and separated via the slanting guide posts 7 and the hydraulic cylinder assemblies 14, the hydraulic cylinder assemblies 14 are fixed by the fixing plates 13 to assist in combination and separation of the side molds 12, the side mold guide rail 15 is connected with the pressure plate 16, the pressure plate 16 is connected with the lower mold 20 and the bottom plate 17, and the stamping guide sleeve 19-1 is connected with the bottom plate 17 and achieves the effect of guiding the liquid pressure head 19.

During working, the mold is preheated to 300° C. before working. The molded surface of the hot mold blank on a machine is coated with a water-based lubricant. Under the drive of a sliding block of a press, a guide plate and the ejector rod fixing plate 4 drive the upper mold core 10 to descend and compress, and simultaneously, the side molds 12 are combined and locked under the action of resultant force of the slanting guide posts 7, the locking modules 20-1 and the hydraulic cylinder systems 14. After smelting, molten liquid magnesium alloy is injected into the cavity of the magnesium alloy hub extrusion casting mold via the lower liquid pressure head 19 in the stamping guide sleeve 19-1, and the molten magnesium alloy is extruded into a solid blank from liquid rheological punching to crystallization solidification. The guide plate and the ejector rod fixing plate 4 drive the upper mold core 10 to ascend under the drive of the sliding block of the press, the side molds 12 are separated under the action of the slanting guide posts 7 and the hydraulic cylinder systems 14, and the blank 11 is separated from the lower mold 20 under the action of the lower liquid pressure head 19; after the blank separation height arrives, an upper ejector rod of the press acts on the connecting plate 23, and the connecting plate 23 drives the large ejector rod 9 and the small ejector rod 21 to eject the blank 11 out of the upper mold core 10 to fall onto the blank tray; and when the upper ejector rod of the press returns to the upper position, the discharge plate 23 returns to the upper large plate 3 under the action of the springs 1 to wait next working state.

What is claimed is:

1. An improved hub extrusion casting mold, comprising springs, bolts, an upper large plate, an ejector rod fixing plate, guide posts, an upper connecting plate, slanting guide posts, an upper mold fixing plate, connecting screws, a large ejector rod, an upper mold core, side molds, fixing plates, hydraulic cylinder assemblies, a side mold guide rail, a pressure plate, a bottom plate, a sprue bush, a lower liquid pressure head, a stamping guide sleeve, a lower mold, locking modules, a small ejector rod, a small guide post, guide sleeves and a discharge plate, wherein the springs are arranged in the guide posts, the large ejector rod and the small ejector rod being fixed onto the discharge plate by the ejector rod fixing plate, the upper mold core being fixed into the upper mold fixing plate via the connecting screws, the locking modules being fixed onto the upper mold fixing plate, the slanting guide posts being fixed in the cavity formed by the upper connecting plate and the upper mold fixing plate, the side molds being combined and separated via the slanting guide posts and the hydraulic cylinder assemblies, the hydraulic cylinder assemblies being fixed by the fixing plates to assist in combination and separation of the side molds, the side mold guide rail being connected with the pressure plate, the pressure plate being connected with the lower mold and the bottom plate, and the stamping guide sleeve being connected with the bottom plate and achieving the effect of guiding the liquid pressure head.
